(19) United States
(12) Patent Application Publication
(10) Pub. No.: US 2025/0125605 A1
(43) Pub. Date: Apr. 17, 2025

(54) Wire Splice for Electrical Cable

(71) Applicant: Intelligent Agricultural Solutions, LLC, Fargo, ND (US)

(72) Inventors: Andrew Kolling, Fargo, ND (US); Elliot Kirschmann, Fargo, ND (US)

(21) Appl. No.: 18/884,649

(22) Filed: Sep. 13, 2024

Related U.S. Application Data
(60) Provisional application No. 63/590,529, filed on Oct. 16, 2023.

(51) Int. Cl. H02G 15/113

(52) U.S. Cl. CPC H02G 15/113

(57) ABSTRACT

A cable splice assembly with an electrical cable that runs along a width of a toolbar that services row units. The cable has an insulative jacket that surrounds and electrically isolates a plurality of conductors. The cable splice assembly has a row unit wiring tail having a plurality of wires and a splice clamp at one end row unit wiring tail that connects the row unit wiring tail to the cable. The splice clamp has a clamp housing that forms a channel shaped to receive the cable and has a plurality of conductive blade-shaped conductors configured to cut through the jacket and into the conductors. A keying mechanism ensures that there is only one way that the cable can be received in the splice clamp when the splice clamp housing is in the closed condition.

### CROSS-REFERENCE TO RELATED APPLICATIONS

This application claims the benefit of the filing date of U.S. Provisional Patent Application 63/590,529, “Wire Splice for Electrical Cable,” filed Oct. 16, 2023, the entire disclosure of which is incorporated herein by reference.

### BACKGROUND OF THE INVENTION

### Field of Invention

This invention relates to electrical connectors that connect an electrical cable that runs along a width of a toolbar to row units on the toolbar, and more particularly a cable splice assembly that connects a row unit wiring tail to the cable at any selected location along the cable.

### Description of Related Art

Many agricultural machines incorporate a toolbar mounted with electrically controlled components mounted along the toolbar. It is to be understood that toolbars for agricultural machines different requirements for the spacing of such components along the toolbar based on various factors including crop type, soil quality, moisture availability and farmer preference. For example, the spacing between row units on row crop planters typically varies from 15 inches to 38 inches, with 30 inches being one common row unit spacing. The spacing layout for spraying and spreading components along a tool bar may also have different requirements.

Multiple different spacing options makes has made it difficult to have a one size fits all solution to provide electrical connections using traditional harnessing. This is especially applicable in the retrofit agricultural market. Changing the spacing of components often requires extensive expenditures in cost and time because wiring solutions are often not operable to fit different machine layouts. Some systems are manufactured with fixed lengths of wire harnessing with wiring splices built in at set distances. However, it would be beneficial to be able to provide common components that could be used for differing toolbar layouts on different implements, or even to retrofit a toolbar with different row unit spacing.

### BRIEF SUMMARY

In one aspect, the invention is directed to a cable splice assembly for use with a toolbar having a plurality of row units, the cable splice assembly including an electrical cable that runs along a width of the toolbar that services the row units. The cable has at least three conductors, with each conductor running parallel to the other conductors in the cable and arranged in a side-by-side configuration such that together the conductors form a linear formation. The cable has an insulative jacket that surrounds and electrically isolates each of the conductors. The cable splice assembly has a row unit wiring tail having a plurality of wires and a splice clamp at one end row unit wiring tail that connects the row unit wiring tail to the cable. The splice clamp has a clamp housing made of an upper portion and a lower portion joined by a hinge and when the upper portion and lower portion are in a closed condition, the clamp housing forming a channel that is shaped to receive the cable. The splice clamp has a plurality of conductive blade-shaped conductors that extend into the channel and are configured to cut through the jacket of the cable and into the conductors when the cable is received in the channel, each one of the plurality of blade-shaped conductors being electrically connected to one of the plurality of wires. The splice clamp further includes a latch that holds the upper portion and lower portion of the clamp housing in the closed condition. The cable splice assembly has a keying mechanism that includes at least one key formed in one of the clamp housing or the jacket configured to interface with a keying groove formed in the other of the clamp housing or jacket, the at least one key and keying groove shaped such that there is only one way that the cable can be received in the channel of the splice clamp housing when the splice clamp housing is in the closed condition.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates a cross section above shows the clamp installed onto the jacketed wiring. This section also demonstrates a potential method of keying.

FIG. 4 illustrates an aspect of the subject matter in accordance with one embodiment.

FIG. 5 illustrates an aspect of the subject matter in accordance with one embodiment.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description. Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” are used as a matter of mere convenience and are determined by standing at the rear of the machine facing in its normal direction of travel. Furthermore, the various components shown or described herein for any specific application of this invention can be varied or altered as anticipated by this invention and the practice of a specific application of any element may already by widely known or used in the art by persons skilled in the art and each will likewise not therefore be discussed in significant detail.

As used herein, the singular forms following “a,” “an,” and “the” are intended to include the plural forms as well, unless the context clearly indicates otherwise. As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded. As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

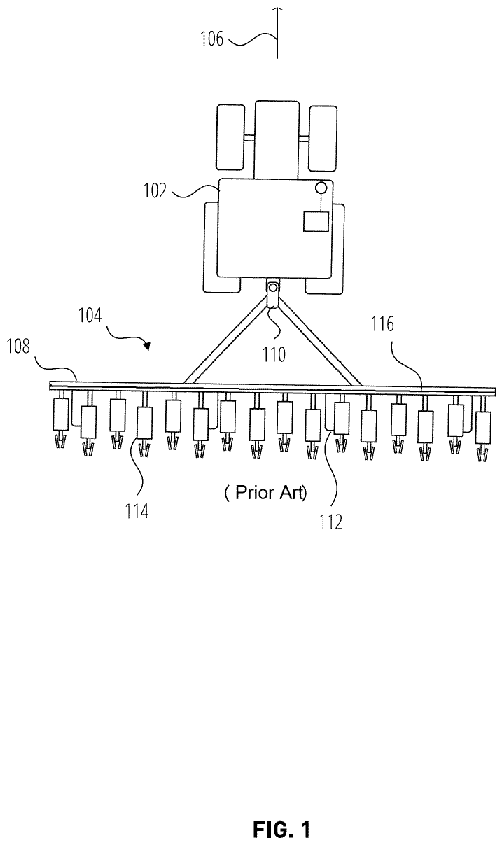

Referring now to the drawings, wherein like reference numbers designate the same or corresponding parts, FIG. 1 is a top plan view of an embodiment of a tractor 102 pulling an implement 104 (shown as a row crop planter) in a forward direction of travel indicated by arrow 106. The implement 104 includes a toolbar 108 that is connected to the tractor's drawbar 110. The toolbar 108 is supported by wheel assemblies 112 adapted to raise and lower the toolbar 108 with respect to the soil surface between an operating position and a travel position. For purposes of this description, the embodiment of the implement 104 and toolbar 108 as a row crop planter is provided by way of example for the purpose of identifying one type of toolbar to which the invention described herein is particularly well suited. One skilled in the art will understand that the invention may be embodied in other types of toolbars, such as one used by an agricultural sprayer or spreader, without departing from the scope of the invention.

The toolbar 108 supports a plurality of row units 114 successively spaced along a width of the toolbar 108. It should be appreciated that the components and configurations that make up the row units 114 may vary depending on the type implement 104. Thus, reference numeral 114 is used to identify a row unit generally, such as any electrically controlled mechanism that is mounted on a toolbar 108 of implement 104. For clarity, row units 114 may be applicable to a row crop planter, an agricultural sprayer, an agricultural spreader, or other implement.

The toolbar 108 has electrical cable 116 that runs along a width of the toolbar 108 and services each of the row units 114. It is to be understood that toolbars for different implements may have different requirements for the spacing of row units along the toolbar based on various factors including crop type, soil quality, moisture availability and farmer preference. For example, the spacing between row units on row crop planters typically varies from 15 inches to 38 inches, with 30 inches being one common row unit spacing. The spacing layout for spraying and spreading implements also may have different requirements. However, it would be beneficial to be able to provide common components that could be used for differing toolbar layouts on different implements, or even to retrofit a toolbar with different row unit spacing.

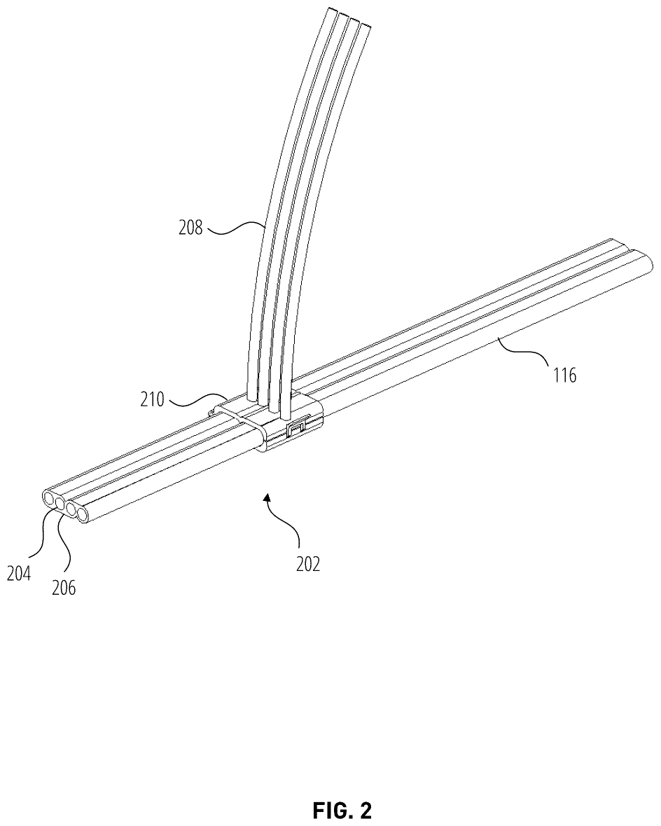

Turning now to FIG. 2, the invention is directed to a cable splice assembly 202 that may be used to electrically attach a row unit 114 to the electrical cable 116 of a toolbar 108 at any desired position along the cable 116. The cable 116 has at least three conductors 204, with each conductor 204 running parallel to the other conductors 204 in the cable 116 and arranged in a side-by-side configuration such that together the conductors 204 form a linear formation. In the illustrated embodiment, the cable 116 has four conductors 204 in such linear formation, however, one skilled in the art will understand that the cable splice assembly 202 may be used to connect to a cable 116 having even more conductors 204. The cable 116 has an insulative jacket 206 that surrounds and electrically isolates each of the conductors 204 of the cable 116. The jacket 206 may be made of plastic, rubber, or other suitable dielectric material.

The cable splice assembly 202 includes a row unit wiring tail 208. The row unit wiring tail 208 has a splice clamp 210 at a proximal end that is used to physically and electrically connect the row unit wiring tail 208 to the cable 116 at a selected location along the cable 116.

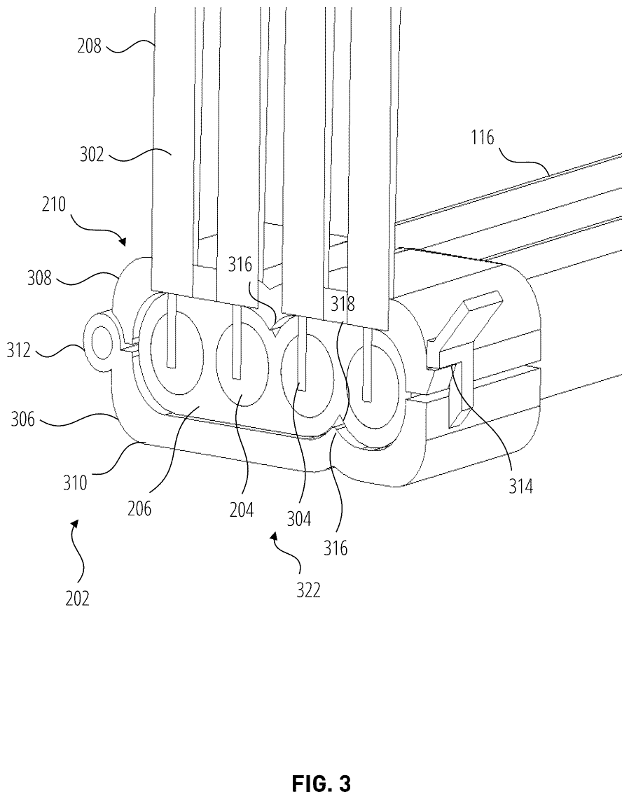

Turning also now to FIG. 3, the row unit wiring tail 208 contains a plurality of wires 302. In the illustrated embodiment, the row unit wiring tail 208 has the same number of wires 302 as the number of conductors 204 in cable 116 such that the splice clamp 210 connects one wire 302 to each of the conductors 204. The wires 302 in the cable splice assembly 202 may be of any suitable gauge of wire and the wires may be made of any suitable conductive material. The wires 302 desirably are jacketed by a plastic, rubber, or other dielectric material. The splice clamp 210 has a clamp housing 306 made of an upper portion 308 and a lower portion 310 joined by a hinge 312.

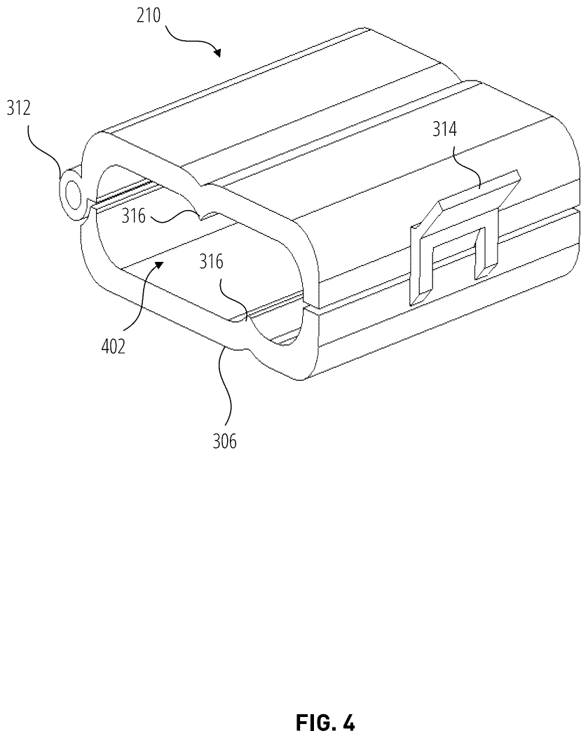

When the upper portion 308 and lower portion 310 are in a closed condition as shown in FIG. 4, the clamp housing 306 forms a channel 402 that is shaped to receive the cable 116. The clamp housing 306 may be made of nylon, polycarbonate, other plastic, or other dielectric material.

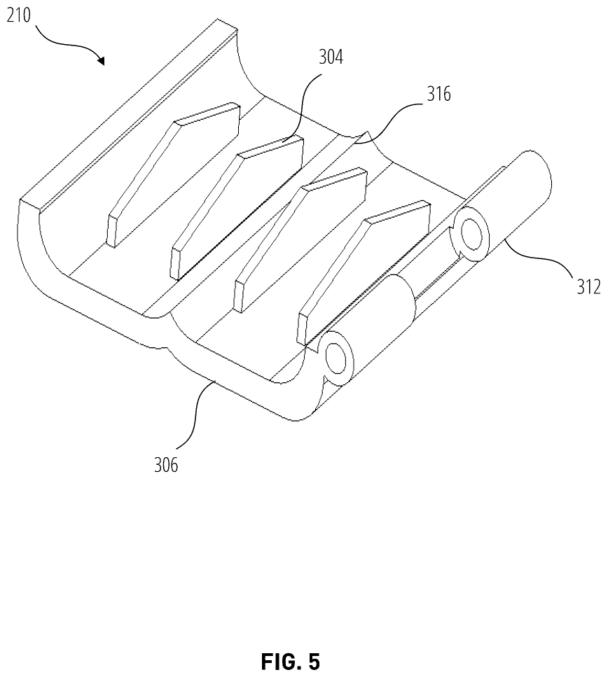

Turning also now to FIG. 5, the splice clamp 210 has a plurality of conductive blade-shaped conductors 304 that are configured to cut through the jacket 206 of the cable 116 and into the conductors 204. Each one of the blade-shaped conductors 304 is electrically connected to one of the wires 302 of the row unit wiring tail 208. The blade-shaped conductors 304 may be made of any suitable conductive material.

A latch 314 is used to close the upper portion 308 and lower portion 310 of the clamp housing 306 around the cable 116. The latch 314 may be of a suitable snap design or use fasteners or other known methods to pivot the upper and lower portions 308 and 310 about the hinge 312 and hold the clamp housing 306 securely around the cable 116. Additionally, it is desirable that the latch 314 provide a mechanical advantage or lever action to help the blade-shaped conductors 304 pierce the jacket 206 of the cable 116 and make electrical connection with the conductors 204.

As perhaps best seen in FIGS. 3 and 4, the cable splice assembly 202 has a keying mechanism 322 configured to ensure correct placement of the splice clamp 210 on the cable 116. In the illustrated embodiment, the splice clamp 210 has at least one key 316 formed in the clamp housing 306 configured to interface with a keying groove 318 on the cable 116. One skilled in the art will understand that the key 316 may alternately be formed on the jacket 206 of the cable and the keying groove 318 may be formed in the clamp housing 306. The shape of the key 316 and the keying groove 318 are such that there is only one way that the cable 116 will fit in the channel 402 of the splice clamp housing 306 and allow the clamp housing 306 to be manipulated into the closed condition. In the illustrated embodiment, the clamp housing 306 has a first key 316 formed in the lower portion 310 and a second key 316 formed in an upper portion 308 and the jacket 206 has a first keying groove 318 on an underside of the cable 116 and a second keying groove 318 on an upper side of the cable 116, with the first keying groove 318 offset from the second keying groove 318 in the linear formation of the conductors 204 such that the splice clamp 210 can only be installed on the cable 116 in a single orientation to prevent backwards or incorrect connection of the wires 302 of the row unit wiring tail 208 with the conductors 204 of the cable 116.

The row unit wiring tail 208 may have a harness or other connector at a distal end of the wiring tail (not shown) that is used to connect to the row unit 114. The cable splice assembly 202 may use any length of jacketed cable 116 and use any number of splice clamps 210 to connect the row units 114 on the toolbar 108.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. A cable splice assembly for use with a toolbar having a plurality of row units, the cable splice assembly comprising:
an electrical cable that runs along a width of the toolbar that services the row units, the cable having at least three conductors, with each conductor running parallel to the other conductors in the cable and arranged in a side-by-side configuration such that together the conductors form a linear formation, the cable having an insulative jacket that surrounds and electrically isolates each of the conductors;
a row unit wiring tail having a plurality of wires and a splice clamp at one end row unit wiring tail that connects the row unit wiring tail to the cable, wherein the splice clamp has a clamp housing made of an upper portion and a lower portion and when the upper portion and lower portion are in a closed condition the clamp housing forms a channel that is shaped to receive the cable, and wherein the splice clamp has a plurality of conductive blade-shaped conductors that extend into the channel and are configured to cut through the jacket of the cable and into the conductors when the cable is received in the channel, each one of the plurality of blade-shaped conductors being electrically connected to one of the plurality of wires; and
a keying mechanism comprising at least one key formed in one of the clamp housing or the jacket configured to interface with a keying groove formed in the other of the clamp housing or jacket, the at least one key and keying groove shaped such that there is only one way that the cable can be received in the channel of the splice clamp housing when the splice clamp housing is in the closed condition.

2. The cable splice assembly of claim 1 wherein the row unit wiring tail has the same number of wires as the number of conductors in the cable such that the splice clamp connects one wire of the plurality of wires to each of the plurality of conductors.

3. The cable splice assembly of claim 1 wherein the splice clamp further comprises a latch that holds the upper portion and lower portion of the clamp housing in the closed condition.

4. The cable splice assembly of claim 3 wherein the latch provides a mechanical advantage to pivot the upper and lower portions about the hinge to help the blade-shaped conductors pierce the jacket of the cable.

5. The cable splice assembly of claim 1 wherein the least one key is formed in the clamp housing and the at least one keying groove is formed in the jacket.

6. The cable splice assembly of claim 1 wherein the clamp housing has a first key formed in the lower portion and a second key formed in the upper portion and the jacket has a first keying groove on an underside of the cable and a second keying groove on an upper side of the cable, with the first keying groove offset from the second keying groove in the linear formation of the conductors.

7. The cable splice assembly of claim 1 wherein the cable has four conductors in the linear formation.

8. The cable splice assembly of claim 1 wherein the upper portion and the lower portion are joined by a hinge.
